(19) United States
(12) Patent Application Publication
(10) Pub. No.: US 2003/0174191 A1
(43) Pub. Date: Sep. 18, 2003

(54) Multi-chamber ink jet print cartridge and method for manufacturing the same

(76) Inventor: Lian Sen Kho, Singapore (MY)

Correspondence Address: HEWLETT-PACKARD COMPANY, Intellectual Property Administration, P.O. Box 272400, Fort Collins, CO, 80527-2400, US

(21) Appl. No.: 10/100,896

(22) Filed: Mar. 18, 2002

(51) Int. Cl. B41J 2/175

(52) U.S. Cl. 347/86

(57) ABSTRACT

A multi-chamber ink jet print cartridge is disclosed. The print cartridge includes a body and a plurality of ink chambers in the body for storing ink. The body of the print cartridge supports at least one printhead for dispensing ink from the plurality of ink chambers. Each of the plurality of ink chambers contains a reticulated polyurethane foam member. The foam member is empirically selected from a corresponding plurality of differently felted foam members. This plurality of foam members are of substantially the same shape and volume but of different densities. The selected foam member provides a pre-use backpressure in a corresponding ink chamber that is within a predetermined range. A method of selecting the foam member and a method of manufacturing the print cartridge are also disclosed.

### BACKGROUND

This invention relates generally to a multi-chamber ink cartridge and a method of manufacturing the same. More particularly, this invention relates to a multi-chamber vented foam-filled ink-jet print cartridge having a foam member in each of a plurality of ink chambers that is selected to provide a backpressure for each ink chamber that is within a predetermined range.

Thermal ink jet (TIJ) technology is widely used in today's printers. Very generally, a TIJ print cartridge includes a TIJ printhead that has an orifice plate attached to a printhead die. Orifices or nozzles in the orifice plate are aligned with transducers on the printhead die. The transducers are selectively actuatable to eject droplets of ink through the corresponding nozzles onto a print medium. U.S. Pat. No. 6,042,225, Altendorf et al., entitled “Ink-jet Pen with One-piece Pen Body” discloses a multi-chamber TIJ print cartridge for dispensing three different colors of ink.

The three different colors of ink are stored in three separate reservoirs or ink chambers. These ink chambers although largely of the same shape and volume, differ in minor structural details. The ink chambers are filled with foam members for maintaining a negative pressure or backpressure so as to prevent drooling of ink out of the printhead. The foam members are cut from a foam block that is felted by compressing and heating the foam block.

Filling the ink chambers with foam members collectively felted to the same degree to have the same density results in a differential between the initial backpressure of the ink chambers after the ink chambers are filled with ink during manufacturing. This backpressure differential may be attributed to the minor structural differences between the ink chambers. Ink in an ink chamber with a higher than necessary initial backpressure cannot be optimally dispensed during use as compared to ink in an ink chamber which has an appropriately selected initial backpressure. In an ink chamber with a higher than necessary initial backpressure, ink will fail to be dispensed prematurely during use, resulting in unnecessary retention and therefore wastage of ink. The backpressure in an ink chamber increases as ink is dispensed. There will come a point in time when the backpressure increases to a level that prevents ink from being further dispensed using the printhead. It is therefore desirable to delay the increase of backpressure to that level.

### SUMMARY

According to an aspect of the present invention, there is provided a multi-chamber ink jet print cartridge. The print cartridge includes a body and a plurality of ink chambers in the body for storing ink. The body of the print cartridge supports at least one printhead for dispensing ink from the plurality of ink chambers. Each of the plurality of ink chambers contains a reticulated polyurethane foam member. The foam member is empirically selected from a corresponding plurality of differently felted foam members. This plurality of foam members are of substantially the same shape and volume but of different densities. The selected foam member provides a pre-use backpressure in a corresponding ink chamber that is within a predetermined range.

According to another aspect of the present invention, there is provided a method of obtaining a pre-use backpressure that is within a predetermined range for each of a plurality of ink chambers of a multiple-chamber ink jet print cartridge. The method includes forming a plurality of the above-described differently felted reticulated polyurethane foam members and empirically selecting one of the plurality of foam members for insertion into each ink chamber to obtain a pre-use backpressure that is within the predetermined range for the ink chamber.

According to yet another aspect of the present invention, there is provided a method of manufacturing the multi-chamber ink jet print cartridge described above. A print cartridge body having a plurality of ink chambers therein for storing ink is formed. At least one printhead is attached to the body for dispensing ink from the plurality of ink chambers. A reticulated polyurethane foam member that is selected according to the above selection method is inserted into each of the plurality of ink chambers for obtaining a pre-use backpressure thereof that is within a predetermined range. The plurality of ink chambers is filled with ink.

### BRIEF DESCRIPTION OF DRAWINGS

The invention will be better understood with reference to the drawings, in which:

FIG. 1 is an isometric drawing of a multi-chamber ink jet print cartridge according to an embodiment of the present invention;

FIG. 2 is an exploded drawing of the ink jet print cartridge in FIG. 1, showing foam members used in the ink jet print cartridge;

FIGS. 3A and 3B are drawings showing a side view of a pair of felting presses in positions prior to and during felting of a slab of foam from which the foam members in FIG. 2 are formed;

FIG. 4 is a drawing showing one of the foam members in FIG. 2 being stamped out of the slab of felted foam produced using the felting presses in FIGS. 3A and 3B;

FIG. 5 is a flowchart showing a sequence of steps for selecting one of a plurality of felted foam members for a corresponding ink chamber of the multi-chamber ink jet print cartridge in FIG. 1 so as to obtain a backpressure that is within a predetermined range for the ink chamber; and

FIG. 6 is a flowchart showing a sequence of steps for manufacturing the multi-chamber ink jet print cartridge in FIG. 1 using foam members selected using the sequence in FIG. 5.

### DETAILED DESCRIPTION

Hereafter, a preferred embodiment of the present invention will be described in the context of an ink jet print cartridge. However, it is to be understood that the invention is usable with any type of ink cartridge having multiple ink chambers that are filled with a porous material member.

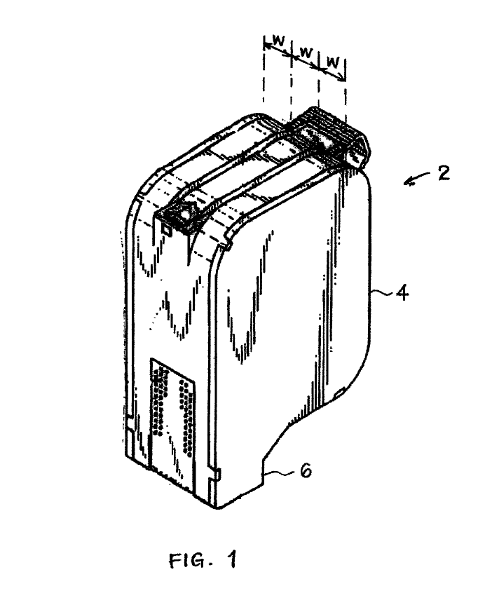

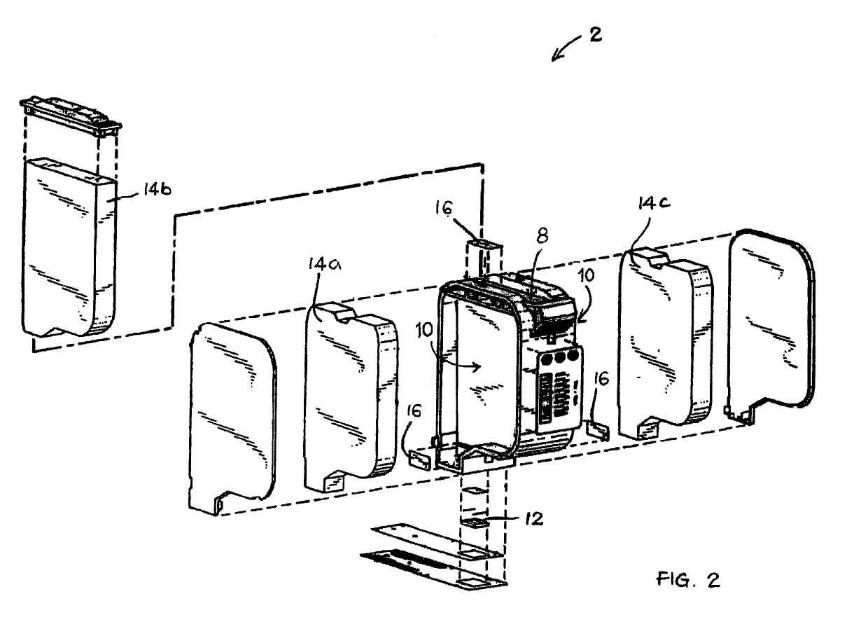

FIG. 1 shows an isometric drawing of a multi-chamber ink jet print cartridge 2 for containing three primary colors of ink. FIG. 2 is an exploded drawing of the print cartridge 2. The print cartridge 2 includes a body 4 having a snout region 6. Each color of ink is contained in a separate reservoir or ink chamber 8, 10 within the body 4. There is a center ink chamber 8 flanked by two outer side ink chambers 10. The center ink chamber 8 and the side ink chambers 10 open to the top and the sides of the print cartridge 2 respectively. These ink chambers 8, 10 are of substantially the same shape and volume, with slight variations in structure. The snout region 6 supports a printhead 12 having an orifice plate (not shown). Formed in the orifice plate are separate groups of nozzles (not shown) for ejecting or dispensing droplets of each color of ink. The ink contained in each of the ink chambers 8, 10 is ducted to its respective group of nozzles 18 through a respective ink pipe or standpipe (not shown) so that the inks do not mix within the print cartridge 2. The location of these standpipes results in slight variations in structure of the ink chambers 8, 10. The inks in the print cartridge 2 are held in their respective ink chambers 8, 10 at less than atmospheric pressure so that the inks do not drool out of the nozzles when the print cartridge 2 is not in use.

In the print cartridge 2, porous material members, such as synthetic foam members 14a-14c, are used in the ink chambers 8, 10 to receive and retain the inks at an appropriate backpressure by capillary action. Each of the foam members 14a-14c is selected from a corresponding plurality of differently felted foam members for obtaining an initial or pre-use backpressure in a corresponding ink chamber 8, 10 that is within a predetermined range of between about 1.5 and 2.0 inches of water. The selection of foam members 14a-14c for the various ink chambers 8, 10 is typically performed during a design phase of the print cartridge 2. This selection will be described in more details later. The foam members 14a-14c selected during the design phase are then used in the manufacturing of the print cartridge 2. There is no need for further selection of foam members 14a-14c during manufacturing. More details of the ink jet print cartridge 2 is available in the U.S. Pat. No. 5,917,527, Boyd et al., entitled “Ink-jet Pen with Near Net Size Porous Member”.

Specifically, each of the standpipes has a standpipe chamber (not shown) through which the inks flow from the respective ink chambers 8, 10 to the printhead 12. At the entrance of each standpipe chamber is a screen filter 16 for preventing contaminants in the inks from reaching the printhead 12. The standpipes press against the foam members 14a-14c to increase the capillarity of the foam members 14a-14c adjacent the standpipes. The screen filters 16 also serve to assist in this compression. The structural details, operation and the method of manufacturing such a print cartridge 2 is described in U.S. Pat. No. 6,042,225, Altendorf et al., entitled “Ink-jet Pen with One-piece Pen Body”.

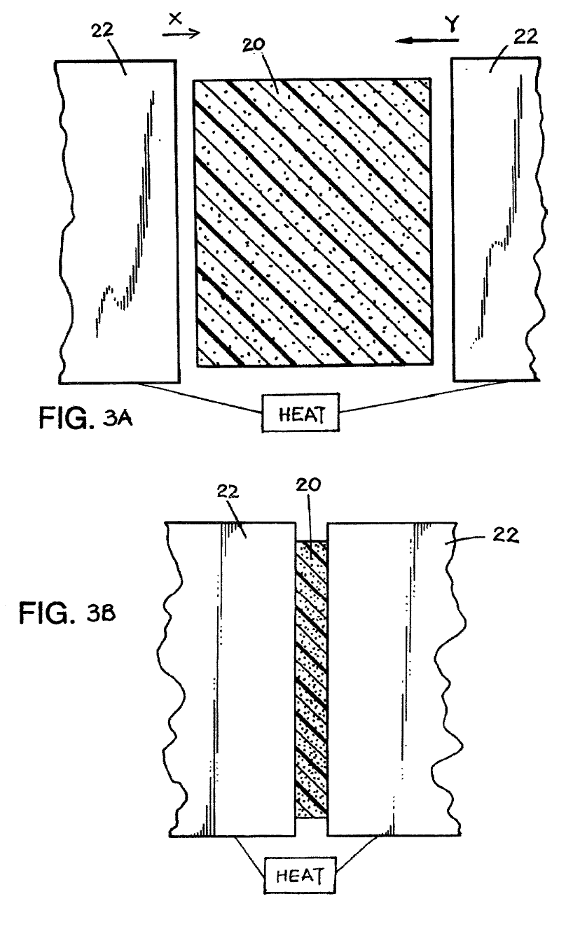

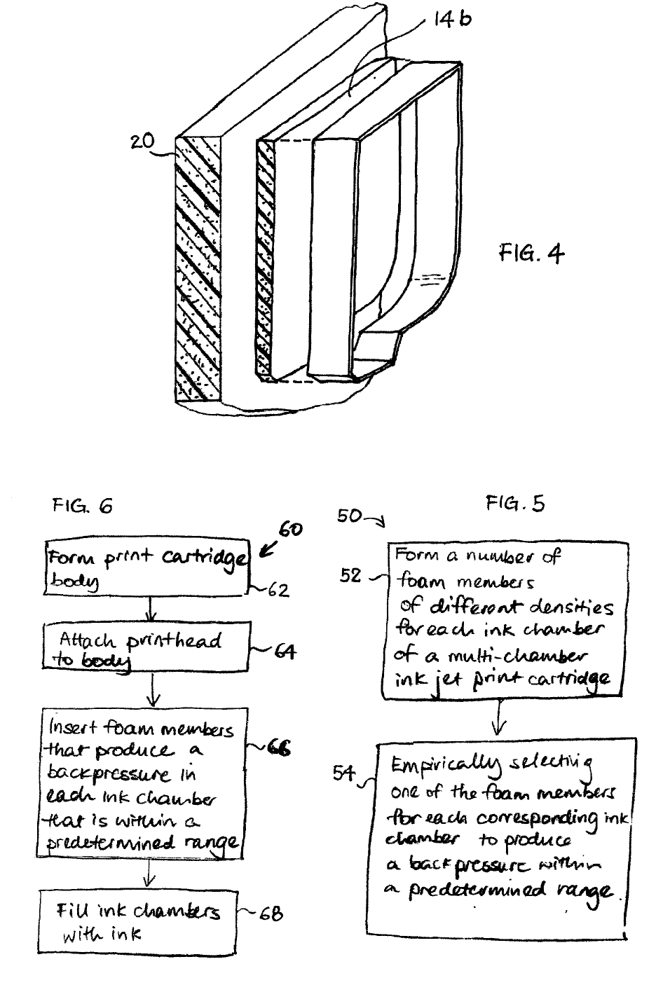

The process of felting a reticulated polyurethane foam slab 20 is next described with the aid of FIGS. 3A and 3B. Before felting, the foam slab 20 has an average pore density of 85-90 pores per inch, a density of about 1.3 lbs. per cubic foot, and a thickness of about 2.3 inches. In FIG. 3A, two felting presses 22 are used to felt the foam slab 20. The felting presses 22 are brought closer together in the directions of the arrows X and Y respectively in FIG. 3A to compress the foam slab 20. As the foam slab 20 is compressed, heat is applied through the felting presses 22 to heat the foam slab 20. The heat causes the internal structure of the foam to take a set and to retain its compressed configuration shown in FIG. 3B. The foam slab 20 is felted at about 360° F. for about 35 minutes. After felting, the foam slab 20 has a thickness of about 0.47 inches, slightly thicker than the width W (FIG. 1) of the ink chambers 8, 10. Thus, as compared to their uncompressed state as shown in FIG. 3A, the foam slab 20 is felted to reduce its thickness by about 4.89 times. In other words, the foam slab 20 is felted to about 20% of its pre-felted state. Foam members similar to the foam members 14a-14c are formed from the felted foam slab 20. The foam members may be either cut with saws or preferably die-stamped as shown in FIG. 4.

Felting makes a foam slab easier to die stamp because the felted foam is stiffer and is resistant to rolling around the edges during the stamping process. A felted foam member is also easier to insert into the ink chambers 8, 10. This is particularly true of the foam member 14b for the center ink chamber 8. The likelihood that wrinkles or non-uniformities occurring in the foam members 14a-14c is also reduced. It is desirable to avoid such non-uniformities. The foam members 14a-14c at positions where the non-uniformities are located have a slightly higher capillarity and will cause a certain amount of ink to be stranded at those positions. Additionally, the stiffness in a felted foam slab helps in maintaining a positive compression and seal between the standpipes and the foam members 14a-14c. The foam members 14a, 14c can be more easily inserted into the side ink chambers 10 as compared to inserting the foam member 14b into the center ink chamber 8. But even in this orientation the additional stiffness as a result of felting helps in keeping the foam members 14a, 14c in compressive contact with the standpipes.

By felting a foam slab, such as the foam slab 20 to about 20% to a thickness of 0.47 inches, the pre-insertion size or volume of the foam members formed is larger than the ink chambers 8, 10. These larger foam members when inserted in the respective ink chambers 8, 10 allow proper compressive contact between the foam members and the interior walls of the print cartridge 2 that define the ink chambers 8, 10 and standpipes. Because of the higher density of the foam members, the foam members can be formed to be closer to the volume of the ink chambers 8, 10. The volume of the foam members is about 1.23 to 1.26 times the volume of the ink chambers 8, 10. The foam members thus have a pre-insertion volume that is about 125% of the volume of the ink chambers 8, 10. A pre-insertion volume that is less than 125% of its post-insertion volume is preferable although a pre-insertion volume of up to about 130% is suitable for use.

FIG. 5 is a flowchart showing a sequence 50 of steps for selecting a foam member 14a-14c for each of the ink chambers 8, 10 to obtain a pre-use backpressure for each of the ink chambers 8, 10 that is within the predetermined range. Broadly, the selection sequence 50 starts with a form foam members step 52, wherein a number of reticulated polyurethane foam members corresponding to each of the ink chambers 8, 10 are formed from differently felted foam slabs. These foam members are formed to be of substantially the same shape and volume as the foam members 14a-14c shown in FIG. 2. These foam members are however of different densities because of the different felting. The details of forming these foam members will be described later.

The selection sequence 50 next proceeds to a selection step 54. In this selection step 54, each of the differently felted foam members corresponding to an ink chamber 8, 10 is inserted into the ink chamber 8, 10. After each foam member is inserted, the ink chamber 8, 10 is then filled with ink and the backpressure of the ink chamber 8, 10 is measured. This pre-use backpressure of the ink chamber 8, 10 is measured at the orifice plate of the printhead 12 preferably a predetermined period after the ink chamber 8, 10 is filled with ink. This predetermined period is about eight hours for reticulated polyurethane foam members. This period may be different for other porous material members. Backpressure measurements may also be taken from other parts of the print cartridge 2. These measurements may result in a different backpressure being recorded for the ink chamber 8, 10. In such a case, the predetermined range of initial or pre-use backpressure may be adjusted accordingly.

From amongst the differently-felted foam members corresponding to the ink chamber 8, 10, a foam member 14a-14c that results in an optimum pre-use backpressure in the predetermined range for the ink chamber 8, 10 is empirically selected. A pre-use backpressure in the predetermined range would prevent ink from drooling from the printhead and would allow more ink to be dispensed as compared with an ink chamber 8, 10 having a pre-use backpressure higher than that in the predetermined range. The empirical selection of a suitable foam member is repeated for each of the other ink chambers 8, 10. The selection of such a foam member 14a-14c for each ink chamber 8, 10 is performed independently of the selection of foam members for the other ink chambers 8, 10. Therefore, the foam members 14a-14c selected for use in the various ink chambers 8, 10 may be of different felting.

The empirical selection of a foam member for an ink chamber 8,10 may be performed in a sequential manner. The differently felted foam members are inserted one at a time into the ink chamber 8, 10 to allow the backpressure to be measured. This step is repeated until a foam member is found to produce a backpressure that is within the predetermined range.

The foam members of different densities corresponding to an ink chamber are formed from foam slabs that are felted to different degrees, for example, from foam slabs of a same material and pre-felted density as the foam slab 20 but of different pre-felted thicknesses. The foam slabs of different thicknesses are felted to a post-felted thickness of about 0.47 inches for use with the print cartridge 2. For example, the foam slabs may have thicknesses ranging from 1.8 to 2.8 inches, in steps of 0.1 inch when it is determined that the foam members felted from the 2.3 inch thick foam slab 20 resulted in an initial or pre-use backpressure that is substantially close to or within the predetermined range of initial backpressure in at least one of the ink chambers 8, 10. From these differently felted foam slabs, foam members of the same shape and volume are formed. For the range of thicknesses above, the amount of felting ranges from between 16.8 and 26%.

FIG. 6 is a flowchart showing a sequence 60 of steps for manufacturing the print cartridge 2. The manufacturing sequence 60 starts in a fabricate step 62, wherein the print cartridge body 4 having the ink chambers 8, 10 therein is formed. The manufacturing sequence 60 proceeds to an attach printhead step 64, wherein at least one printhead 14 is attached to the print cartridge body 4. The sequence next proceeds to an insert foam members step 66, wherein a reticulated polyurethane foam member 14a-14c is inserted into each of the ink chambers 8, 10. The particular reticulated foam member 14a-14c in each ink chamber is previously empirically selected using the selection sequence 50 described above. The manufacturing sequence 60 ends in a fill ink step, wherein the ink chambers 8, 10 are filled with ink.

Advantageously, the multi-chamber ink jet print cartridge 2 described above allows optimal use of ink stored in each of the ink chambers 8, 10. By ensuring that the backpressure in each of the ink chambers is kept within the predetermined range when the print cartridge 2 is manufactured, the time required for the backpressure to build up during use of the print cartridge 2 to a level where ink can no longer be properly dispensed is delayed. Consequently, more ink can be dispensed from each of the ink chambers 8, 10.

Although the present invention is described using the above-described embodiment, various changes are possible. As an example, instead of having three ink chambers 8, 10, the ink jet print cartridge 2 may include only two ink chambers or four or more ink chambers. As another example, instead of being of a single material, the foam members 14a-14c may be of more than one material.

I claim:

1. A multi-chamber ink jet print cartridge comprising:
a body;
a plurality of ink chambers in the body for storing ink;
at least one printhead supported by the body for dispensing ink from the plurality of ink chambers; and
a reticulated polyurethane foam member in each of the plurality of ink chambers, the foam member being empirically selected from a corresponding plurality of differently felted foam members of substantially the same shape and volume but of different densities, for obtaining a pre-use backpressure that is within a predetermined range for each of the plurality of ink chambers.

2. An ink cartridge according to claim 1, wherein the predetermined range of backpressure is between about 1.5 and 2.0 inches of water.

3. An ink cartridge according to claim 2, wherein the foam member is formed to between about 1.25 and 1.3 times the volume of a corresponding ink chamber.

4. An ink cartridge according to claim 1, wherein the foam member in each of the plurality of ink chambers is empirically selected independently of selection of foam members for the other ink chambers of the plurality of ink chambers.

5. A method of obtaining a pre-use backpressure that is within a predetermined range for each of a plurality of ink chambers of a multiple-chamber ink jet print cartridge comprising:
forming a plurality of differently felted reticulated polyurethane foam members corresponding to each of the plurality of ink chambers, the plurality of foam members being of substantially the same shape and volume but of different densities; and
for each of the plurality of ink chambers, empirically selecting one of the plurality of foam members for insertion into the ink chamber to obtain a pre-use backpressure that is within the predetermined range for the ink chamber.

6. A method according to claim 5, wherein the predetermined range of backpressure is between about 1.5 and 2.0 inches of water.

7. A method according to claim 6, wherein each foam member is formed to between about 1.25 and 1.3 times the volume of a corresponding ink chamber.

8. A method according to claim 5, wherein empirically selecting one of the plurality of foam members for insertion into the ink chamber includes empirically selecting one of the plurality of foam members for insertion into the ink chamber independently of the selection of foam members for the other ink chambers of the plurality of ink chambers.

9. A method according to claim 5, wherein empirically selecting one of the plurality of foam members for insertion into the ink chamber includes:
inserting one of the plurality of foam members into the ink chamber;
filling the ink chamber with ink after inserting the foam member into the ink chamber;
measuring the pre-use backpressure of the ink chamber;
determining if the measured backpressure is within the predetermined range; and
repeating the inserting, filling and measuring steps using another one of the plurality of foam members if required until the measured backpressure of the ink chamber is within the predetermined range.

10. A method according to claim 9, wherein measuring the pre-use backpressure of the ink chamber includes measuring the pre-use backpressure of the ink chamber a predetermined period after the ink chamber is filled with ink.

11. A method of manufacturing a multi-chamber ink jet print cartridge comprising:
forming a print cartridge body having a plurality of ink chambers therein for storing ink;
attaching at least one printhead to the body for dispensing ink from the plurality of chambers;
inserting a reticulated polyurethane foam member that is empirically selected from a corresponding plurality of differently felted foam members of substantially the same shape and volume but of different densities in each of the plurality of ink chambers for obtaining a pre-use backpressure thereof that is within a predetermined range; and
filling each of the plurality of ink chambers with ink.

12. A method according to claim 11, wherein the predetermined range of backpressure is between about 1.5 and 2.0 inches of water.

13. A method according to claim 12, wherein each foam member is formed to between about 1.25 and 1.3 times the volume of a corresponding ink chamber.

14. A method according to claim 11, wherein inserting a reticulated polyurethane foam member includes inserting a reticulated polyurethane foam member that is empirically selected from a corresponding plurality of differently felted foam members independently of selection of foam members for the other ink chambers of the plurality of ink chambers
